(19) United States
(12) Patent Application Publication
(10) Pub. No.: US 2007/0247728 A1
(43) Pub. Date: Oct. 25, 2007

(54) Optical unit of a laser module

(76) Inventors: Clark Lin, Dashi (TW); Szutsun-Simon Ou, Dashi (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/708,324

(22) Filed: Feb. 21, 2007

(30) Foreign Application Priority Data
Apr. 21, 2006 (TW) 095206791

(51) Int. Cl. G02B 3/02

(52) U.S. Cl. 359/719

(57) ABSTRACT

An optical unit of a laser module is installed at front end of a laser diode of a drive circuit board. The optical unit includes a sleeve that is integrally injection molded from plastic material. Moreover, an optical lens is formed at the top of the sleeve. The inner wall of the sleeve is provided with a focus adjusting slope facing the laser diode. In this way, the problems of the prior art with respect to the high material and assembly cost can be resolved by the invention. In other words, the invention ensures the simplification of elements and the reduction of material and assembly cost.

### BACKGROUND OF THE INVENTION

1. Field of the Invention

The invention relates to an optical unit of a laser module, and more particularly to a design by use of an optical lens that is integrally injection molded.

2. Description of the Related Art

As shown in FIGS. 1 and 2, a conventional laser module includes a laser diode 10 disposed on a drive circuit board 20. An optical unit including a lens sleeve 30, an optical lens 40, an 0-ring 50 and a heat sink 60, is mounted on the laser diode 10. Most components of this conventional optical unit are made by metal processing. Therefore, the material and assembly cost is very high. Thus, the conventional laser module that is installed in price-sensitive electronic products is uncompetitive in price.

Moreover, as shown in FIG. 2, the housing of the lens sleeve 30 and the heat sink 60 is made of metal like copper. As a result, it is not possible to check the lighting status of the laser diode 10 from the outside. In addition, the focus of the conventional optical unit of the laser module has to be adjusted during the assembly by means that the external thread 61 of the heat sink 60 is screwed to the internal thread 31 of the lens sleeve 30 for fixing the O-ring 50 between the optical lens 40 and the heat sink 60. The heat sink 60 is movable into the lens sleeve 30 by turning the heat sink 60. The focus of the projecting beam can be properly adjusted by loosening or tightening the optical lens 40 with the aid of the slight flexibility and the deformation of the O-ring 50. At last, the fixing effect can be achieved by glue. However, this kind of adjustment requires a lot of time. Meanwhile, the accuracy will be affected such that the projecting beam of the laser diode 10 and the optical lens 40 are not coaxial. Accordingly, the imaging of the projecting beam will have an arched deviation. As a result, a readjustment is required. This is regarded as impractical.

### SUMMARY OF THE INVENTION

It is a primary object of the invention to eliminate the above-mentioned drawbacks with respect to the high material and assembly cost and to provide an optical unit of a laser module having the advantage with respect to the reduction of the material and assembly cost.

It is another object of the invention to provide an optical unit of a laser module with which the lighting status can be observed from the outside. Meanwhile, the focus between the projecting beam and the optical lens can be adjusted rapidly, accurately and conveniently.

In order to achieve the above-mentioned objects, an optical unit of a laser module is installed at front end of a laser diode of a drive circuit board. The optical unit includes a sleeve that is integrally injection molded from plastic material. Moreover, an optical lens is formed at the top of the sleeve. The inner wall of the sleeve is provided with a focus adjusting slope facing the laser diode.

### BRIEF DESCRIPTION OF THE FIGURES

The accomplishment of this and other objects of the invention will become apparent from the following descriptions and its accompanying figures of which:

FIG. 1 is an exploded perspective view of a conventional laser module;

FIG. 2 is a cutaway view of the conventional laser module after assembly;

FIG. 3 is an exploded perspective view of the invention;

FIG. 4 is a cutaway view of the invention; and

FIG. 5 is a cutaway view of the invention after assembly.

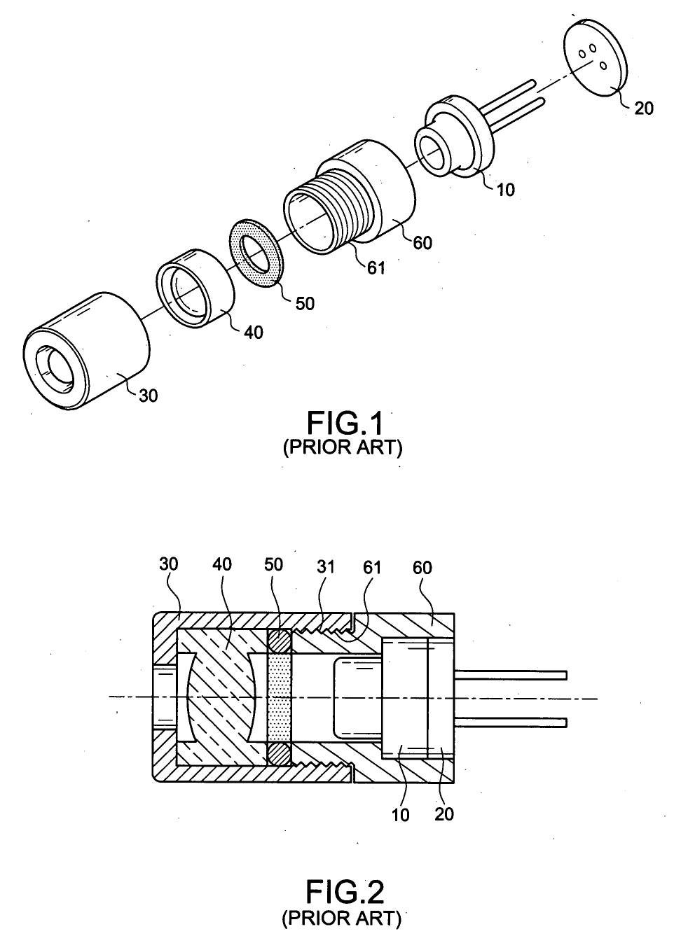

### DETAILED DESCRIPTION OF THE PREFERRED EMBODIMENT

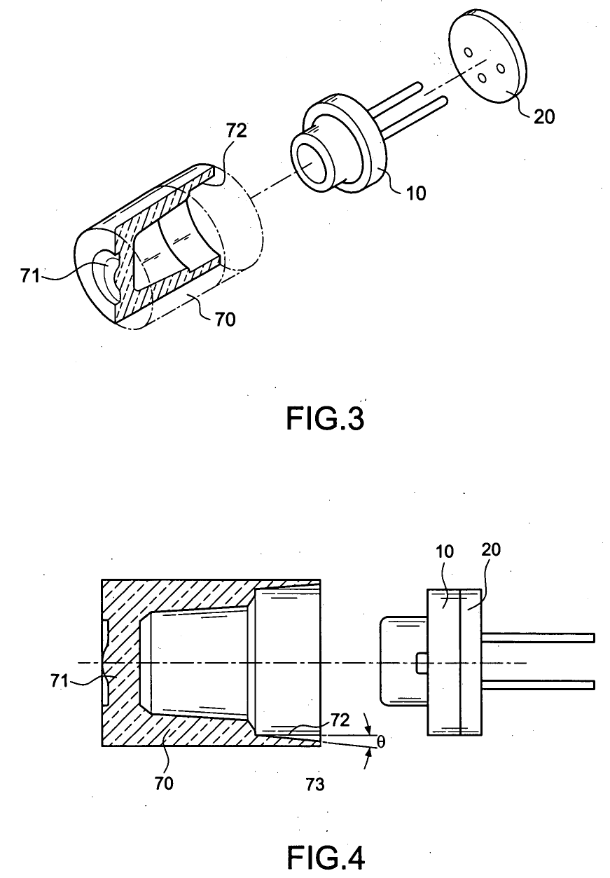

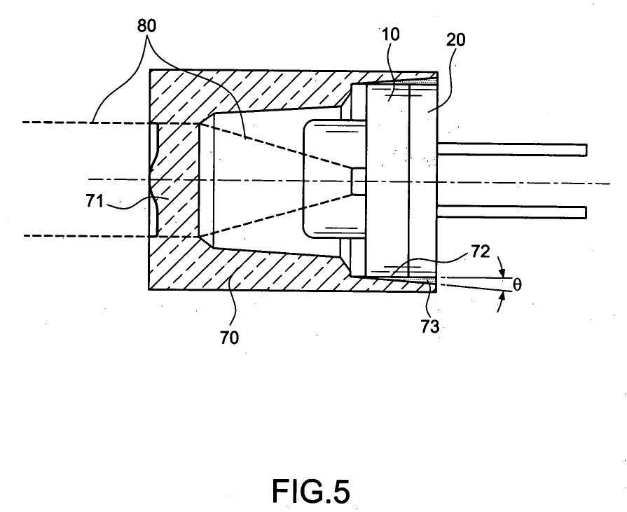

First of all, referring to FIGS. 2 and 3, the invention is installed at front end of a laser diode 10 of a drive circuit board 20. The invention includes a transparent sleeve 70 that is integrally injection molded from plastic material. An aspheric lens 71 is formed at the top of the transparent sleeve 70. The inner wall of the transparent sleeve 70 is provided with a focus adjusting slope 72 facing the laser diode 10. The focus adjusting slope 72 is outwardly inclined and has an angle (θ) with respect to the horizontal plane. As shown in FIG. 5, the conventional optical unit is so changed that it is injection molded out of transparent plastic material, thereby reducing the quantity of required components. Accordingly, the simplification of the components is ensured, thereby reducing the material and assembly cost. Moreover, the exterior allows a more complicated variation according to different requirements. Due to the transparency of the material, the examiner can learn from the outside if the laser diode lights up. In this way, the risk of direct observation can be avoided. Meanwhile, the lighting status can be observed from the outside.

What is more important, the focus adjustment of the invention is very convenient and precise. As shown in FIG. 5, when the laser diode 10 and the drive circuit board 20 are inserted along the focus adjusting slope 72 into the transparent sleeve 70, the adjustment can be done by an axial displacement on the focus adjusting slope 72 such that an optimal focus between a projecting beam 80 and the aspheric lens 71 is created. Thereafter, the laser diode 10 is fixed by glue 73. Unlike the conventional turning way, the focus adjustment in accordance with the invention can avoid undesirable arched displacement. Besides, the transparent sleeve 70 is so transparent that an easy observation is guaranteed during the adjustment process. Therefore, the invention permits a convenient adjustment and a high accuracy.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An optical unit of a laser module installed at front end of a laser diode of a drive circuit board, the optical unit having a sleeve that is integrally injection molded from plastic material, an optical lens being formed at the top of the sleeve, the inner wall of the sleeve being provided with a focus adjusting slope facing the laser diode.

2. The optical unit of a laser module as recited in claim 1 wherein the sleeve is transparent.

3. The optical unit of a laser module as recited in claim 1 wherein the optical lens is aspheric.
